(19) United States
(12) Patent Application Publication
(10) Pub. No.: US 2024/0209910 A1
(43) Pub. Date: Jun. 27, 2024

(54) FRICTION MATERIAL

(71) Applicant: AKEBONO BRAKE INDUSTRY CO., LTD., Tokyo (JP)

(72) Inventors: Shigeru NAKAJIMA, Tokyo (JP); Motoyuki MIYAJI, Tokyo (JP); Hiroshi YAMAMOTO, Tokyo (JP)

(73) Assignee: AKEBONO BRAKE INDUSTRY CO., LTD., Tokyo (JP)

(21) Appl. No.: 18/536,420

(22) Filed: Dec. 12, 2023

(30) Foreign Application Priority Data
Dec. 21, 2022 (JP) 2022-204336

(51) Int. Cl. F16D 69/02

(52) U.S. Cl. CPC F16D 69/026; F16D 2200/0065

(57) ABSTRACT

The present invention relates to a friction material including: a friction modifier; a fiber base material; and a binder, in which 2 mass % to 12 mass % of a θ-alumina particle is contained as the friction modifier, 0.2 mass % to 0.6 mass % of an alumina fiber is contained as the fiber base material, and the friction material is free of a copper component.

### CROSS-REFERENCE TO RELATED APPLICATIONS

The disclosure of Japanese Patent Application No. 2022-204336 filed on Dec. 21, 2022, including specification, drawings and claims is incorporated herein by reference in its entirety.

### TECHNICAL FIELD

The present invention relates to a friction material, and more particularly to a friction material used for a brake pad, a brake lining, a clutch facing, or the like of industrial machines, railway vehicles, freight vehicles, passenger vehicles, or the like.

### BACKGROUND ART

A friction material is used in brakes such as a disc brake and a drum brake, or clutches, and plays a braking role by friction with a mating material such as a disc brake. Properties required of the friction material include, for example, a high friction coefficient, resistance to a decrease in friction coefficient under a high load (fade properties), and low aggressiveness against a mating material.

The friction material is made of raw materials such as a fiber base material that acts as a reinforcement, a friction modifier that provides a friction effect and adjusts friction performance thereof, and a binder that integrates these components. Copper, which has been used as one of the raw materials, stretches on a friction surface to form a film, and can thus contribute to stability of the friction coefficient at a high speed and a high deceleration and during fading before a thermal history. However, in recent years, from the viewpoint of environmental measures, a friction material that does not substantially contain copper is required, and various materials are being considered as substitutes for copper.

For example, a friction material described in Patent Literature 1 exhibits excellent friction coefficient, crack resistance, and wear resistance by containing lithium potassium titanate and graphite even when a content of copper or a copper alloy is small. A friction material described in Patent Literature 2 contains alumina particles whose main component is θ-alumina particles, and thereby increases stability of the friction coefficient against changes in a humidity environment and prevents aggressiveness against a mating material.

### CITATION LIST

### Patent Literature

Patent Literature 1: JP6760449B
Patent Literature 2: JP2017-160296A

### SUMMARY OF INVENTION

### Technical Problem

Although the techniques in Patent Literature 1 and Patent Literature 2 are expected to improve the friction coefficient during fading, the improvement in the friction coefficient at a high speed and a high deceleration before a thermal history is insufficient. In addition, when the friction material contains a large amount of θ-alumina particles, there is a concern that heat crack resistance deteriorates when the friction material is immersed in water (water and heat crack resistance).

An object of the present invention is to provide a friction material that has both stable friction properties at a high speed and a high deceleration before a thermal history and water and heat crack resistance even containing no copper.

### Solution to Problem

As a result of intensive studies, the present inventors have found that when a friction material contains a specific amount of θ-alumina particles as a friction modifier and a specific amount of alumina fiber as a fiber base material, the above problem can be solved. Thus, the present invention has been completed.

That is, the present invention relates to the following friction material.

A friction material including:
a friction modifier;
a fiber base material; and
a binder, in which
2 mass % to 12 mass % of θ-alumina particles are contained as the friction modifier,
0.2 mass % to 0.6 mass % of an alumina fiber is contained as the fiber base material, and
a copper component is not contained.

### Advantageous Effects of Invention

According to the friction material of the present invention, when a specific amount of θ-alumina particles and a specific amount of alumina fiber are used in combination, it is possible to provide a friction material having an improved friction coefficient at a high speed and a high deceleration and during fading before a thermal history, and excellent water and heat crack resistance.

### DESCRIPTION OF EMBODIMENTS

Hereinafter, a friction material according to the present invention will be described in detail.

A friction material according to an embodiment of the present invention is a friction material containing a friction modifier, a fiber base material, and a binder, in which 2 mass % to 12 mass % of a θ-alumina particle is contained as the friction modifier, 0.2 mass % to 0.6 mass % of an alumina fiber is contained as the fiber base material, and the friction material is free of a copper component.

### <Friction Modifier>

The friction modifier is used to impart desired friction properties such as wear resistance, heat resistance, and fade resistance to the friction material.

The friction material according to the embodiment of the present invention contains θ-alumina particles as the friction modifier in order to stabilize the friction properties at a high speed and a high deceleration before a thermal history.

The θ-alumina particles are obtained by firing aluminum hydroxide hydrate such as boehmite or pseudo-boehmite as a starting material at approximately 800° C. to 1000° C. When the starting material is fired, a dehydration reaction occurs, and the θ-alumina particles develop a surface structure with many pores in the crystal structure due to the dehydration. It is presumed that when the θ-alumina particles are contained in the friction material, the pores adsorb tar (liquid decomposition product) and gas generated by thermal decomposition of organic components during high-temperature braking, thereby preventing a decrease in effectiveness due to fading. Note that the present invention is not limited to such a presumed theory.

A specific surface area of the θ-alumina particles is preferably 40 m²/g to 150 m²/g. When the specific surface area of the θ-alumina particles is 40 m²/g or more, sufficient humidity control properties can be obtained, the desired effects of the present invention can be obtained, and high fade properties can be obtained since tar (liquid decomposition product) and gases generated during braking are sufficiently adsorbed. In addition, hardness of the 0-alumina particles does not become too high, and aggressiveness against a mating material can be prevented. Note that the specific surface area in the present invention is a value measured by a BET method using nitrogen gas adsorption.

In addition, the specific surface area is preferably 150 m²/g or less since when it is too large, an amount of the binder adsorbed onto the θ-alumina particles increases, so that the friction modifier and the fiber base material may not be sufficiently integrated, thermal moldability may deteriorate, and cracks may occur in the friction material.

The specific surface area is more preferably 60 m²/g or more, still more preferably 120 m²/g or less, and even more preferably 100 m²/g or less.

An average particle diameter of the θ-alumina particles is preferably 1 μm to 300 μm. When the average particle diameter of the θ-alumina particles is 1 μm or more, sufficient braking effectiveness can be obtained. In addition, when the average particle diameter is 300 μm or less, the aggressiveness against a mating material can be prevented, and there is no concern of deterioration of the wear resistance of the friction material. The average particle diameter is more preferably 20 μm or more, still more preferably 250 μm or less, and even more preferably 100 μm or less.

Note that the average particle diameter of the θ-alumina particles can be determined based on the value of a particle diameter equivalent to 50% volume-based cumulative percentage (D50) measured with a laser diffraction particle size distribution analyzer.

The friction material according to the embodiment of the present invention may contain any one of α-alumina particles, β-alumina particles, γ-alumina particles, 8-alumina particles, or the like as alumina particles other than the θ-alumina particles.

The friction material according to the embodiment of the present invention contains 2 mass % to 12 mass % of the θ-alumina particles in the friction material. When the friction material contains 2 mass % or more of the θ-alumina particles, the fade resistance of the friction material can be sufficiently obtained. The content of the θ-alumina particles in the friction material is preferably 3 mass % or more, more preferably 4 mass % or more, and still more preferably 5 mass % or more.

When the content of the θ-alumina particles in the friction material is 12 mass % or less, the thermal moldability is good, and the aggressiveness against a mating material is prevented. The content of the θ-alumina particles in the friction material is preferably 11 mass % or less, more preferably 10 mass % or less, and still more preferably 9 mass % or less.

In the friction material according to the embodiment of the present invention, other commonly used friction modifiers can be used as long as they comply with the gist of the present invention.

Examples of the other friction modifiers include an inorganic filler, an organic filler, an abrasive, a lubricant, and a metal powder.

Examples of the inorganic filler include inorganic materials such as titanates such as potassium titanate, lithium titanate, lithium potassium titanate, sodium titanate, calcium titanate, magnesium titanate, and potassium magnesium titanate; barium sulfate, calcium carbonate, calcium hydroxide, vermiculite, and mica. These may be used alone or in combination of two or more thereof.

A content of the inorganic filler is preferably 30 mass % to 80 mass %, and more preferably 40 mass % to 70 mass %, in the entire friction material.

Examples of the organic filler include various rubber powders (a raw rubber powder, a tire powder, etc.), rubber dust, resin dust, cashew dust, tire tread, and melamine dust. These may be used alone or in combination of two or more thereof.

A content of the organic filler is preferably 1 mass % to 15 mass %, and more preferably 1 mass % to 10 mass %, in the entire friction material.

Examples of the abrasive include zirconium oxide, alumina, silica, magnesium oxide, zirconia, zirconium silicate, chromium oxide, triiron tetroxide (Fe₃O₄), and chromite. These may be used alone or in combination of two or more thereof.

The abrasive is used in an amount of preferably 1 mass % to 40 mass % and more preferably 10 mass % to 35 mass % in the entire friction material, in terms of a total amount of the abrasive containing the θ-alumina particles.

Examples of the lubricant include graphite, coke, antimony trisulfide, molybdenum disulfide, tin sulfide, and polytetrafluoroethylene (PTFE). These may be used alone or in combination of two or more thereof.

A content of the lubricant is preferably 1 mass % to 20 mass %, and more preferably 3 mass % to 15 mass %, in the entire friction material.

Examples of metal powder include powders of aluminum, tin, and zinc. These may be used alone or in combination of two or more thereof.

A content of the metal powder is preferably 0 mass % to 10 mass %, and more preferably 0 mass % to 5 mass %, in the entire friction material.

A content of the friction modifier may be adjusted as appropriate depending on the desired friction properties. A total amount of the friction modifier containing the θ-alumina particles is preferably 60 mass % to 90 mass %, and more preferably 65 mass % to 85 mass %, in the entire friction material.

### <Fiber Base Material>

The fiber base material is used for reinforcement when used as a friction material.

The friction material according to the embodiment of the present invention contains an alumina fiber as the fiber base material. A content of the alumina fiber in the friction material according to the embodiment of the present invention is 0.2 mass % to 0.6 mass %. When the friction material according to the embodiment of the present invention contains 0.2 mass % to 0.6 mass % of the alumina fiber, stable friction properties at a high speed and a high deceleration before a thermal history and water and heat crack resistance are obtained. It is presumed that when a specific amount of θ-alumina particles is contained as the friction modifier, tar (liquid decomposition product) and gas generated during braking are adsorbed, so that an abrasive effect is more effective even when a specific amount of alumina fiber is contained.

By controlling a firing temperature in an alumina fiber production process, the abradability of the friction material according to the present invention can be reduced, and by selecting an appropriate blending amount of the alumina fiber, the aggressiveness against a mating material of the friction material according to the present invention can be reduced.

The content of the alumina fiber in the entire friction material is preferably 0.3 mass % to 0.6 mass %, and more preferably 0.4 mass % to 0.6 mass %.

Note that the alumina fiber is an artificial mineral fiber containing alumina (Al₂O₃) and silica (SiO₂) as main components. A chemical composition ratio of Al₂O₃ and SiO₂ in the alumina fiber is preferably Al₂O₃: SiO₂=70 to 80:30 to 20, and more preferably Al₂O₃: SiO₂=70:30.

In addition, the alumina fiber preferably has an average fiber length of 50 μm to 150 μm and an average fiber diameter of 1 μm to 10 μm. Note that in the present invention, the average fiber length and the average fiber diameter of the alumina fiber can be measured by observation with a microscope or the like.

The alumina fiber can be produced by a known method. For example, a so-called precursor fiber method is used in which an organic polymer is added to a solution of aluminum salts or the like to increase the viscosity, which is then mechanically fiberized and fired.

Examples of the fiber base material include an organic fiber and an inorganic fiber in addition to those described above. These fiber base materials may be used alone or in combination of two or more thereof.

Examples of the organic fiber include an aromatic polyamide (aramid) fiber and a flame-resistant acrylic fiber.

Examples of the inorganic fiber include a biosoluble inorganic fiber, a ceramic fiber, a glass fiber, a carbon fiber, and rock wool. Examples of the biosoluble inorganic fiber include biosoluble ceramic fibers such as a SiO₂—CaO—MgO-based fiber, a SiO₂—CaO—MgO—Al₂O₃-based fiber, and a SiO₂—MgO—SrO-based fiber, and biosoluble rock wool.

From the viewpoint of ensuring strength of the friction material, a content of the fiber base material is preferably 3 mass % to 30 mass % and more preferably 5 mass % to 20 mass % in the entire friction material, in terms of a total amount of the fiber base material containing the alumina fiber.

### <Binder>

The binder is used to integrate the fiber base material and the friction modifier contained in the friction material. Examples of the binder include thermosetting resins such as a straight phenol resin, various elastomer-modified phenol resins, a melamine resin, an epoxy resin, and a polyimide resin. Examples of the elastomer-modified phenol resins include an acrylic rubber-modified phenol resin, a silicone rubber-modified phenol resin, and an NBR rubber-modified phenol resin. These binders can be used alone or in combination of two or more thereof.

Among these, it is preferable to use a silicone rubber-modified phenol resin because it can improve the water and heat crack resistance of the friction material. This is thought to be due to elasticity and water repellency of a silicone rubber. A content of the silicone rubber in the silicone rubber-modified phenol resin is preferably 10 mass % to 30 mass %. In addition, from the viewpoint of the water and heat crack resistance, a content of the silicone rubber-modified phenol resin is preferably 1 mass % to 5 mass % in the entire friction material. Further, from the viewpoint of the water and heat crack resistance, a content of the silicone rubber in the friction material is preferably 0.1 mass % to 1.5 mass %, and more preferably 0.5 mass % to 1.5 mass %, in the entire friction material.

In order to ensure sufficient mechanical strength and wear resistance, a content of the binder is preferably 1 mass % to 20 mass % and more preferably 3 mass % to 15 mass % in the entire friction material, in terms of a total amount of the binder containing the silicone rubber-modified phenol resin.

In addition to the fiber base material, the friction modifier, and the binder, the friction material according to the embodiment of the present invention may contain other materials as necessary.

However, from the viewpoint of reducing an environmental load, the friction material according to the present invention does not contain a copper component. The expression “free of a copper component” and “not contain a copper component” mean that it does not substantially contain copper, and does not exclude that it inevitably contains copper. More specifically, it means that a content of copper as an element is 0.5 mass % or less.

When the friction material according to the embodiment of the present invention contains a specific amount of θ-alumina particles as the friction modifier and a specific amount of alumina fiber as the fiber base material, it is possible to achieve both stable friction properties at a high speed and a high deceleration before a thermal history and water and heat crack resistance even containing no copper.

The friction material according to the embodiment of the present invention can be produced by a known production process. For example, the friction material can be prepared through steps such as preforming, hot molding, heating, and grinding a friction material composition.

A method for producing a brake pad provided with the friction material generally includes the following steps:
(a) a step of forming a steel plate (pressure plate) into a predetermined shape by using a sheet metal press;
(b) a step of applying a degreasing treatment, a chemical conversion treatment, and a primer treatment to the above pressure plate and coating the pressure plate with an adhesive;
(c) a step of blending powder raw materials such as a fiber base material, a friction modifier, and a binder, performing sufficient homogenization by mixing to obtain a friction material composition, and performing molding at a predetermined pressure at room temperature to prepare a preformed body;
(d) a hot molding step of integrally fixing the preformed body and the pressure plate coated with the adhesive by applying a predetermined temperature and pressure (molding temperature: 130° ° C. to 180ºC, molding pressure: 30 MPa to 80 MPa, molding time: 2 minutes to 10 minutes); and
(e) a step of performing after-cure (150° C. to 300° C., 1 hour to 5 hours) and finally performing finishing treatments such as grinding, scorching, and painting.

With such steps, the friction material according to the embodiment of the present invention can be produced.

Based on the above, the present description discloses the following friction material.

(1) A friction material including:
a friction modifier;
a fiber base material; and
a binder, in which
2 mass % to 12 mass % of a θ-alumina particle is contained as the friction modifier,
0.2 mass % to 0.6 mass % of an alumina fiber is contained as the fiber base material, and
the friction material is free of a copper component.

(2) The friction material according to (1), in which the θ-alumina particle has a specific surface area of 40 m²/g to 150 m²/g.

(3) The friction material according to (1) or (2), in which the alumina fiber has an average fiber length of 50 μm to 150 μm.

(4) The friction material according to any one of (1) to (3), in which the θ-alumina particle has an average particle diameter of 1 μm to 300 μm.

(5) The friction material according to any one of (1) to (4), in which a silicone rubber-modified phenol resin is contained as the binder.

(6) The friction material according to (5), in which a content of a silicone rubber in the silicone rubber-modified phenol resin is 10 mass % to 30 mass %.

(7) The friction material according to (5) or (6), in which a content of the silicone rubber-modified phenol resin is 1 mass % to 5 mass %.

### EXAMPLES

Hereinafter, the present invention will be further described with reference to Examples and Comparative Examples, but the present invention is not limited to the following examples.

### <Production of Friction Material>

### Examples 1 to 13 and Comparative Examples 1 to 7

Blending materials shown in Table 1 to Table 3 were charged into a mixer and mixed at room temperature for 4 minutes to obtain a friction material composition. Thereafter, the obtained friction material composition was subjected to the following steps of (i) preforming, (ii) hot molding, and (iii) heat treatment to prepare a brake pad containing a friction material.

### (i) Preforming

The mixture was charged into a mold of a preforming press and molded at room temperature at 20 MPa for 10 seconds to prepare a preformed body.

### (ii) Hot Molding

The preformed body was charged into a hot molding mold, metal plates (pressure plates) coated with an adhesive in advance were stacked, and hot press molding was performed at 150° ° C. and 35 MPa for 6 minutes.

(iii) Heat Treatment

The hot press molded body was subjected to a heat treatment at 250° C. for 3 hours and then the surface thereof was grinded.

Next, the surface of the hot press molded body was finished by a painting to obtain a friction material.

### Phenol Resin A: Straight Phenol Resin

Phenol resin B: silicone rubber-modified phenol resin (RS-2210 MB manufactured by Gun Ei Chemical Industry Co., Ltd., content of silicone rubber: 10 mass %) Phenol resin C: silicone rubber-modified phenol resin (RS-2230 MB manufactured by Gun Ei Chemical Industry Co., Ltd., content of silicone rubber: 30 mass %) 0-Alumina particles: specific surface area 100 m²/g, average particle diameter 20 μm

### Alumina Fiber: Average Fiber Length 100 μm, Average Fiber Diameter 4.5 μm

The obtained friction material was evaluated for friction properties at a high speed and a high deceleration before a thermal history, aggressiveness against a rotating disc rotor at low pressure, and water and heat crack resistance, by the following methods and criteria.

<Evaluation of Friction Properties at High Speed and High Deceleration before Thermal History>

A friction test was conducted on the obtained friction material using a full-sized dynamometer, and friction coefficients of second effect and a first fading were measured.

For the second effect, the friction coefficient at the second effect was measured at an initial speed of 130 km/h and a braking deceleration of 5.88 m/s² in accordance with JASO C 406:2000.

For the first fading, the lowest friction coefficient during 10 times of braking at the first fading was measured in accordance with JASO C 406:2000.

The evaluation criteria for the second effect and the first fading are as follows.

### [Evaluation Criteria for Second Effect]

A: 0.35 or more
B: 0.30 or more and less than 0.35
C: less than 0.30

### [Evaluation Criteria for First Fading]

A: 0.30 or more
B: 0.25 or more and less than 0.30
C: less than 0.25

### <Evaluation of Aggressiveness Against Rotating Disc Rotor at Low Pressure (Aggressiveness Against Mating Material)>

A test piece (20 mm×30 mm) was cut out from the obtained friction material, pressed against a disc rotor (material: FC200) using a 1/7 scale tester at a surface pressure of 0.06 MPa, and idly rotated at room temperature (about 20° C.) at a speed of 60 km/h, and an rotor wear amount (μm) after 40 hours was measured. The evaluation criteria for the aggressiveness against a rotating disc rotor at low pressure are as follows.

### [Evaluation Criteria]

A: less than 15 μm
B: 15 μm or more and less than 20 μm
C: 20 μm or more

### <Evaluation of Water and Heat Crack Resistance>

A cycle in which the obtained friction material was immersed in water, taken out therefrom, heated in a heating furnace at 200° ° C. for 10 hours, and then left at room temperature until the temperature of the friction material reached room temperature was performed for 5 cycles, and then occurrence of cracks was visually evaluated. The evaluation criteria for the water and heat crack resistance are as follows.

### [Evaluation Criteria]

A: No cracks occur or hair crack (minor crack) occurs
B: crack length is less than 15 mm
C: crack length is 15 mm or more

The results of each test are shown in Table 1 to Table 3.

TABLE 1

| | | | | Example | | | | | | |
|---|---|---|---|---|---|---|---|---|---|---|
| (mass %) | | | | 1 | 2 | 3 | 4 | 5 | 6 | 7 |
| Blending | Binder | | Phenol resin A | 8.0 | 8.0 | 8.0 | 8.0 | 8.0 | 8.0 | 8.0 |
| composition | | | Phenol resin B | — | — | — | — | — | — | — |
| | | | (silicone rubber: 10 mass %) | | | | | | | |
| | | | Phenol resin C | — | — | — | — | — | — | — |
| | | | (silicone rubber: 30 mass %) | | | | | | | |
| | Friction | Organic | Cashew dust | 4.0 | 4.0 | 4.0 | 4.0 | 4.0 | 4.0 | 4.0 |
| | modifier | filler | Tire tread | 2.0 | 2.0 | 2.0 | 2.0 | 2.0 | 2.0 | 2.0 |
| | | Inorganic | Barium sulfate | 21.0 | 18.0 | 16.0 | 13.0 | 11.0 | 16.0 | 16.0 |
| | | filler | Calcium hydroxide | 3.0 | 3.0 | 3.0 | 3.0 | 3.0 | 3.0 | 3.0 |
| | | | Potassium titanate | 23.0 | 23.0 | 23.0 | 23.0 | 23.0 | 23.0 | 23.0 |
| | | | Mica | 2.0 | 2.0 | 2.0 | 2.0 | 2.0 | 2.0 | 2.0 |
| | | Abrasive | θ-Alumina particles | 2.0 | 5.0 | 7.0 | 10.0 | 12.0 | 7.0 | 7.0 |
| | | | Zirconium silicate | 12.0 | 12.0 | 12.0 | 12.0 | 12.0 | 12.0 | 12.0 |
| | | | Triiron tetroxide | 8.0 | 8.0 | 8.0 | 8.0 | 8.0 | 8.0 | 8.0 |
| | | Solid | Graphite | 6.0 | 6.0 | 6.0 | 6.0 | 6.0 | 6.0 | 6.0 |
| | | lubricant | Tin sulfide | 2.0 | 2.0 | 2.0 | 2.0 | 2.0 | 2.0 | 2.0 |

| | Fiber base material | Alumina fiber | 0.5 | 0.5 | 0.5 | 0.5 | 0.5 | 0.2 | 0.6 |
|---|---|---|---|---|---|---|---|---|---|
| | | Aramid fiber | 4.0 | 4.0 | 4.0 | 4.0 | 4.0 | 4.0 | 4.0 |
| | | Biosoluble inorganic fiber | 2.5 | 2.5 | 2.5 | 2.5 | 2.5 | 2.8 | 2.4 |
| Total (mass %) | | | 100.0 | 100.0 | 100.0 | 100.0 | 100.0 | 100.0 | 100.0 |
| Evaluation | JASO C406 | Friction coefficient at second | 0.34 | 0.34 | 0.35 | 0.35 | 0.36 | 0.31 | 0.38 |
| | | effect at 130 km/h and 5.88 m/s² | | | | | | | |
| | | Friction coefficient at first fading | 0.26 | 0.28 | 0.30 | 0.31 | 0.32 | 0.30 | 0.31 |
| | | (MIN value) | | | | | | | |
| | Aggressiveness against rotating disc rotor at | | 11 | 12 | 13 | 15 | 17 | 12 | 15 |
| | low pressure [μm] | | | | | | | | |
| Determination | JASO C406 | Friction coefficient at second | B | B | A | A | A | B | A |
| | | effect at 130 km/h and 5.88 m/s² | | | | | | | |
| | | Friction coefficient at first fading | B | B | A | A | A | A | A |
| | | (MIN value) | | | | | | | |
| | Aggressiveness against rotating disc rotor | | A | A | A | B | B | A | B |
| | at low pressure | | | | | | | | |
| | Water and heat | Evaluation of cracks of | A | A | A | B | B | A | A |
| | crack resistance | friction material after 5 cycles | | | | | | | |
| | test | | | | | | | | |

TABLE 2

| | | | | Example | | | | | |
|---|---|---|---|---|---|---|---|---|---|
| (mass %) | | | | 8 | 9 | 10 | 11 | 12 | 13 |
| Blending | Binder | | Phenol resin A | 7.0 | 5.0 | 3.0 | 7.0 | 5.0 | 3.0 |
| composition | | | Phenol resin B | 1.0 | 3.0 | 5.0 | — | — | — |
| | | | (silicone rubber: 10 mass %) | | | | | | |
| | | | Phenol resin C | — | — | — | 1.0 | 3.0 | 5.0 |
| | | | (silicone rubber: 30 mass %) | | | | | | |
| | Friction | Organic | Cashew dust | 4.0 | 4.0 | 4.0 | 4.0 | 4.0 | 4.0 |
| | modifier | filler | Tire tread | 2.0 | 2.0 | 2.0 | 2.0 | 2.0 | 2.0 |
| | | Inorganic | Barium sulfate | 11.0 | 11.0 | 11.0 | 11.0 | 11.0 | 11.0 |
| | | filler | Calcium hydroxide | 3.0 | 3.0 | 3.0 | 3.0 | 3.0 | 3.0 |
| | | | Potassium titanate | 23.0 | 23.0 | 23.0 | 23.0 | 23.0 | 23.0 |
| | | | Mica | 2.0 | 2.0 | 2.0 | 2.0 | 2.0 | 2.0 |
| | | Abrasive | θ-Alumina particles | 12.0 | 12.0 | 12.0 | 12.0 | 12.0 | 12.0 |
| | | | Zirconium silicate | 12.0 | 12.0 | 12.0 | 12.0 | 12.0 | 12.0 |
| | | | Triiron tetroxide | 8.0 | 8.0 | 8.0 | 8.0 | 8.0 | 8.0 |
| | | Solid | Graphite | 6.0 | 6.0 | 6.0 | 6.0 | 6.0 | 6.0 |
| | | lubricant | Tin sulfide | 2.0 | 2.0 | 2.0 | 2.0 | 2.0 | 2.0 |

| | Fiber base material | Alumina fiber | 0.5 | 0.5 | 0.5 | 0.5 | 0.5 | 0.6 |
|---|---|---|---|---|---|---|---|---|
| | | Aramid fiber | 4.0 | 4.0 | 4.0 | 4.0 | 4.0 | 4.0 |
| | | Biosoluble inorganic fiber | 2.5 | 2.5 | 2.5 | 2.5 | 2.5 | 2.4 |
| Total (mass %) | | | 100.0 | 100.0 | 100.0 | 100.0 | 100.0 | 100.0 |
| Evaluation | JASO C406 | Friction coefficient at second | 0.36 | 0.35 | 0.34 | 0.35 | 0.34 | 0.33 |
| | | effect at 130 km/h and 5.88 m/s² | | | | | | |
| | | Friction coefficient at first fading | 0.32 | 0.31 | 0.30 | 0.30 | 0.30 | 0.29 |
| | | (MIN value) | | | | | | |
| | Aggressiveness against rotating disc rotor at | | 17 | 16 | 15 | 16 | 15 | 14 |
| | low pressure [μm] | | | | | | | |
| Determination | JASO C406 | Friction coefficient at second | A | A | B | A | B | B |
| | | effect at 130 km/h and 5.88 m/s² | | | | | | |
| | | Friction coefficient at first fading | A | A | A | A | A | B |
| | | (MIN value) | | | | | | |
| | Aggressiveness against rotating disc rotor | | B | B | B | B | B | A |
| | at low pressure | | | | | | | |
| | Water and heat crack | Evaluation of cracks of | A | A | A | A | A | A |
| | resistance test | friction material after 5 cycles | | | | | | |

TABLE 3

| | | | | Comparative Example | | | | | | |
|---|---|---|---|---|---|---|---|---|---|---|
| (mass %) | | | | 1 | 2 | 3 | 4 | 5 | 6 | 7 |
| Blending | Binder | | Phenol resin A | 8.0 | 8.0 | 8.0 | 8.0 | 8.0 | 8.0 | 8.0 |
| composition | | | Phenol resin B | — | — | — | — | — | — | — |
| | | | (silicone rubber: 10 mass %) | | | | | | | |
| | | | Phenol resin C | — | — | — | — | — | — | — |
| | | | (silicone rubber: 30 mass %) | | | | | | | |
| | Friction | Organic | Cashew dust | 4.0 | 4.0 | 4.0 | 4.0 | 4.0 | 4.0 | 4.0 |
| | modifier | filler | Tire tread | 2.0 | 2.0 | 2.0 | 2.0 | 2.0 | 2.0 | 2.0 |
| | | Inorganic | Barium sulfate | 23.0 | 16.0 | 23.0 | 22.0 | 8.0 | 16.0 | 16.0 |
| | | filler | Calcium hydroxide | 3.0 | 3.0 | 3.0 | 3.0 | 3.0 | 3.0 | 3.0 |
| | | | Potassium titanate | 23.0 | 23.0 | 23.0 | 23.0 | 23.0 | 23.0 | 23.0 |
| | | | Mica | 2.0 | 2.0 | 2.0 | 2.0 | 2.0 | 2.0 | 2.0 |
| | | Abrasive | θ-Alumina particles | — | 7.0 | — | 1.0 | 15.0 | 7.0 | 7.0 |
| | | | Zirconium silicate | 12.0 | 12.0 | 12.0 | 12.0 | 12.0 | 12.0 | 12.0 |
| | | | Triiron tetroxide | 8.0 | 8.0 | 8.0 | 8.0 | 8.0 | 8.0 | 8.0 |
| | | Solid | Graphite | 6.0 | 6.0 | 6.0 | 6.0 | 6.0 | 6.0 | 6.0 |
| | | lubricant | Tin sulfide | 2.0 | 2.0 | 2.0 | 2.0 | 2.0 | 2.0 | 2.0 |

| | Fiber base material | Alumina fiber | — | — | 0.5 | 0.5 | 0.5 | 0.1 | 1.0 |
|---|---|---|---|---|---|---|---|---|---|
| | | Aramid fiber | 4.0 | 4.0 | 4.0 | 4.0 | 4.0 | 4.0 | 4.0 |
| | | Biosoluble inorganic fiber | 3.0 | 3.0 | 2.5 | 2.5 | 2.5 | 2.9 | 2.0 |
| Total (mass %) | | | 100.0 | 100.0 | 100.0 | 100.0 | 100.0 | 100.0 | 100.0 |
| Evaluation | JASO C406 | Friction coefficient at second | 0.28 | 0.29 | 0.33 | 0.33 | 0.37 | 0.29 | 0.38 |
| | | effect at 130 km/h and 5.88 m/s² | | | | | | | |
| | | Friction coefficient at first fading | 0.23 | 0.30 | 0.24 | 0.24 | 0.33 | 0.30 | 0.31 |
| | | (MIN value) | | | | | | | |
| | Aggressiveness against rotating disc rotor at | | 5 | 9 | 9 | 10 | 19 | 10 | 22 |
| | low pressure [μm] | | | | | | | | |
| Determination | JASO C406 | Friction coefficient at second | C | C | B | B | A | C | A |
| | | effect at 130 km/h and 5.88 m/s² | | | | | | | |
| | | Friction coefficient at first fading | C | A | C | C | A | A | A |
| | | (MIN value) | | | | | | | |
| | Aggressiveness against rotating disc rotor | | A | A | A | A | B | A | C |
| | at low pressure | | | | | | | | |
| | Water and heat | Evaluation of cracks of friction | A | A | A | A | C | A | A |
| | crack resistance | material after 5 cycles | | | | | | | |
| | test | | | | | | | | |

As seen from the results in Table 1 to Table 3, the friction materials in Examples 1 to 7 containing a specific amount of θ-alumina particles and a specific amount of alumina fiber are friction materials excellent in the friction properties at a high speed and a high deceleration before a thermal history, the aggressiveness against a rotating disc rotor at low pressure, and the water and heat crack resistance. The friction materials in Comparative Examples 1 to 3 that do not contain either or both of the θ-alumina particles and the alumina fiber and the friction materials in Comparative Examples 4 to 7 in which the content of either the θ-alumina particles or the alumina fiber is outside the range of the present invention do not satisfy the criteria in at least one of the friction properties at a high speed and a high deceleration before a thermal history, the aggressiveness against an rotating disc rotor at low pressure, and the water and heat crack resistance.

In particular, as seen from comparison of the friction property tests for the friction material in Example 3 and the friction materials in Comparative Examples 1 to 3, when both a specified amount of θ-alumina particles and a specified amount of alumina fiber are contained, compared to the case where only one of them is contained, the friction coefficient at the second effect can be increased while maintaining the friction coefficient at the first fading, and the friction properties at a high speed and a high deceleration before a thermal history are improved.

In addition, as seen from the results in Table 2, the friction materials in Examples 8 to 13 containing a silicone rubber-modified phenol resin as a binder have improved water and heat crack resistance compared to the friction material in Example 5, which has the same composition except for the type of the binder.

The present invention is described in detail with reference to specific embodiments, but it is apparent for those skilled in the art that various changes or modifications can be added without departing from the spirit and the scope of the present invention. This application is based upon Japanese Patent Application (No. 2022-204336), filed on Dec. 21, 2022, the contents of which are incorporated herein by reference.

What is claimed is:

1. A friction material comprising:
a friction modifier;
a fiber base material; and
a binder, wherein
2 mass % to 12 mass % of a θ-alumina particle is contained as the friction modifier,
0.2 mass % to 0.6 mass % of an alumina fiber is contained as the fiber base material, and
the friction material is free of a copper component.

2. The friction material according to claim 1, wherein the θ-alumina particle has a specific surface area of 40 m²/g to 150 m²/g.

3. The friction material according to claim 1, wherein the alumina fiber has an average fiber length of 50 μm to 150 μm.

4. The friction material according to claim 1, wherein the θ-alumina particle has an average particle diameter of 1 μm to 300 μm.

5. The friction material according to claim 1, wherein a silicone rubber-modified phenol resin is contained as the binder.

6. The friction material according to claim 5, wherein a content of a silicone rubber in the silicone rubber-modified phenol resin is 10 mass % to 30 mass %.

7. The friction material according to claim 5, wherein a content of the silicone rubber-modified phenol resin is 1 mass % to 5 mass %.
